(19) United States
(12) Patent Application Publication
(10) Pub. No.: US 2010/0255885 A1
(43) Pub. Date: Oct. 7, 2010

(54) INPUT DEVICE AND METHOD FOR MOBILE TERMINAL

(75) Inventor: Myeong Lo LEE, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/718,157

(22) Filed: Mar. 5, 2010

(30) Foreign Application Priority Data
Apr. 7, 2009 (KR) 10-2009-0029724

(51) Int. Cl. H04W 88/02

(52) U.S. Cl. 455/566

(57) ABSTRACT

An input device and method for a mobile terminal are provided. The inputting method of a mobile terminal preferably includes: generating a specific illuminance event and a specific touch event; determining whether a specific user function of the mobile terminal is set to execute according to generating of the specific illuminance event and the specific touch event; and activating the user function if a specific user function is set.

### CLAIM OF PRIORITY

This application claims priority from Korean application No. 10-2009-0029724, filed Apr. 7, 2009, the contents of which are hereby incorporated by reference in its entirety.

### BACKGROUND OF THE INVENTION

1. Field of the Invention

The present invention relates to an input device and method for a mobile terminal. More particularly, the present invention relates to an input device and method for a mobile terminal for controlling various functions of the mobile terminal based on illuminance events and touch events received from an illuminance sensor unit.

2. Description of the Related Art

Nowadays, mobile terminals have become increasing popular and are widely used because of their portability. Particularly, a mobile communication terminal for performing voice communication while in moving in cars, trains, buses, walking, etc is used by a majority of people in Korea, and other countries in Asia, whereas in continents such as Europe and North America such mobile terminals are becoming more common every day. The typical mobile communication terminal includes various functions in addition to a major function of transmitting and receiving voice communication and text communication information between users. For example, a conventional mobile terminal often includes an MP3 function corresponding to a file reproduction function or an image capturing function corresponding to a digital camera for capturing images. A conventional mobile terminal also usually supports functions of executing mobile games or Arcade games.

Some of the conventional mobile terminals have adopted a touch screen method of controlling the mobile terminal on the basis of a touch event generated to create an input signal or a keypad method of controlling the mobile terminal according to a key input of a key. The size of a display unit is limited because of already small size restrictions (i.e. for the major characteristic of a mobile terminal). Accordingly, a scheme in which the keypad is removed from the mobile terminal, so that the display unit is extended, and the extended display unit is used as a touch screen has recently been used. The touch screen is, however, configured to output a specific image to the display unit and to link a specific function to the output image. Consequently, the generation of an input signal through the touch screen is problematic in that very monotonous operations are repeatedly performed. Further, a mobile terminal including a conventional touch screen is disadvantageous in that an input signal to perform a specific function cannot be rapidly generated.

### SUMMARY OF THE INVENTION

The present invention provides an input device and method for a mobile terminal that supports a function of generating complex input signals using an illuminance sensor unit and a touch panel provided in the mobile terminal and also supports fast access to and fast operations of user functions of the mobile terminal based on the generated complex input signals.

In accordance with an exemplary aspect of the present invention, an input device of a mobile terminal, includes: an illuminance sensor for detecting a change in an intensity of illumination and for generating an illuminance event according to the detected change; a touch screen comprising a display unit and a touch panel for generating a touch event in response to sensing a touch; a storage unit comprising a machine readable medium for storing an application program comprising machine executable code corresponding to a user function automatically performed when a specific illuminance event and a specific touch event occur; and a controller for determining whether generating of the specific illuminance event and the specific touch event has occurred and controlling activation of a preset user function associated with generating of the specific illuminance event and the specific touch event.

Moreover, a method of processing input by a mobile terminal preferably includes: (a) generating a specific illuminance event and a specific touch event; (b) determining by a controller whether a specific user function of the mobile terminal associated with the generating of the specific illuminance event and the specific touch event is set; and (c) activating the user function by the controller if the specific user function in (b) is set.

### BRIEF DESCRIPTION OF THE DRAWINGS

The exemplary objects, features and advantages of the present invention will become more apparent from the following detailed description in conjunction with the accompanying drawings, in which:

FIG. 1 is a diagram illustrating an external casing of a mobile terminal according to an exemplary embodiment of the present invention;

FIG. 2 is a block diagram illustrating an exemplary configuration of the mobile terminal of FIG. 1;

FIG. 3 is a block diagram illustrating an exemplary configuration of a controller of the mobile terminal of FIG. 1;

FIG. 4 illustrates examples of user function setting screens of the mobile terminal of FIG. 1;

FIG. 5 illustrates examples of screens explaining operation of a speed dial function of the mobile terminal of FIG. 1;

FIG. 6 illustrates examples of screens explaining operation of a message writing function of the mobile terminal of FIG. 1; and

FIG. 7 is a flowchart illustrating exemplary operation an inputting method of the mobile terminal according to another exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or like parts. The views in the drawings are not intended to be to in scale or correctly proportioned. Detailed descriptions of well-known functions and structures incorporated herein may be omitted to avoid obscuring appreciation of the subject matter of the present invention by a person of ordinary skill in the art.

While the present invention may be embodied in many different forms, specific exemplary embodiments of the present invention are shown in drawings and are described herein in detail, with the understanding that the present disclosure is to be considered as an exemplification of the principles of the invention and is not intended to limit the claimed invention to the specific embodiments illustrated herein.

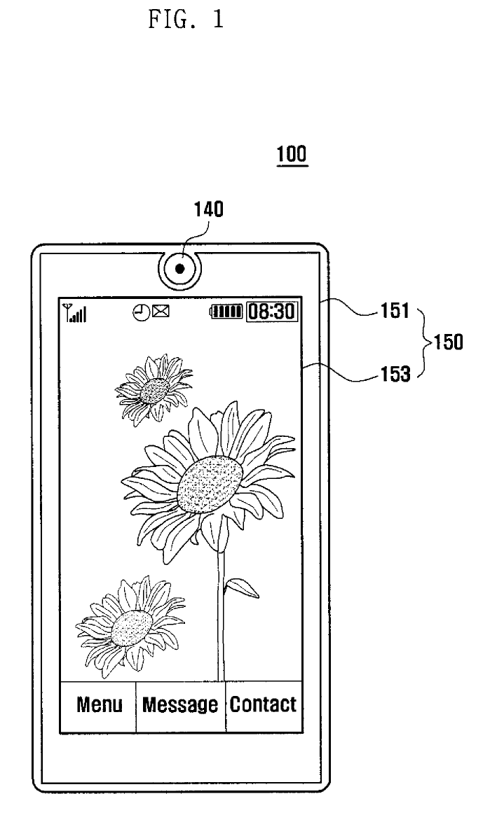

FIG. 1 is a diagram illustrating an external casing of a mobile terminal according to an exemplary embodiment of the present invention.

Referring now to FIG. 1, a mobile terminal 100 according to the present exemplary embodiment preferably includes an illuminance sensor unit 140, a touch screen 150, and an external casing in which the illuminance sensor unit 140 and the touch screen 150 are disposed. The mobile terminal 100 supports generation of input signals to enable a user to control user functions of the mobile terminal 100 using the illuminance sensor unit 140 and the touch screen 150. That is, the user of the mobile terminal 100 can generate an input signal (hereinafter, an ‘illuminance event’) using the illuminance sensor unit 140 and a touch event using the touch screen 150. For example, the user of the mobile terminal 100 can control power supplied to the mobile terminal 100 and to use the user functions (e.g. a message writing function, call connection function, and etiquette mode switch function) of the mobile terminal 100 using the touch screen 150. Here, the user can activate corresponding functions using the illuminance sensor unit 140 and the touch screen 150. Further, the user of the mobile terminal 100 can use the illuminance sensor unit 140 and the touch screen 150 in order to generate an input signal to switch a screen in an activated function.

In FIG. 1, the mobile terminal 100 has a shape in which the illuminance sensor unit 140 is disposed at an upper central portion of the mobile terminal 100 with the touch screen 150 vertically located and the touch panel 151 of the touch screen 150 is configured to enclose the illuminance sensor unit 140 and located at the front side of the external casing, however the presently claimed invention is not limited to the above shape. For example, the touch panel 151 of the touch screen 150 may be disposed to cover the illuminance sensor unit 140, and the illuminance sensor unit 140 may be located at various positions (e.g. a lateral surface or a rear surface of the mobile terminal 100) as well as an upper central portion of the mobile terminal 100 according to a designer's intention. Further, the touch panel 151 of the touch screen 150 may be disposed to cover only a region of the display unit 153 separately from the illuminance sensor unit 140.

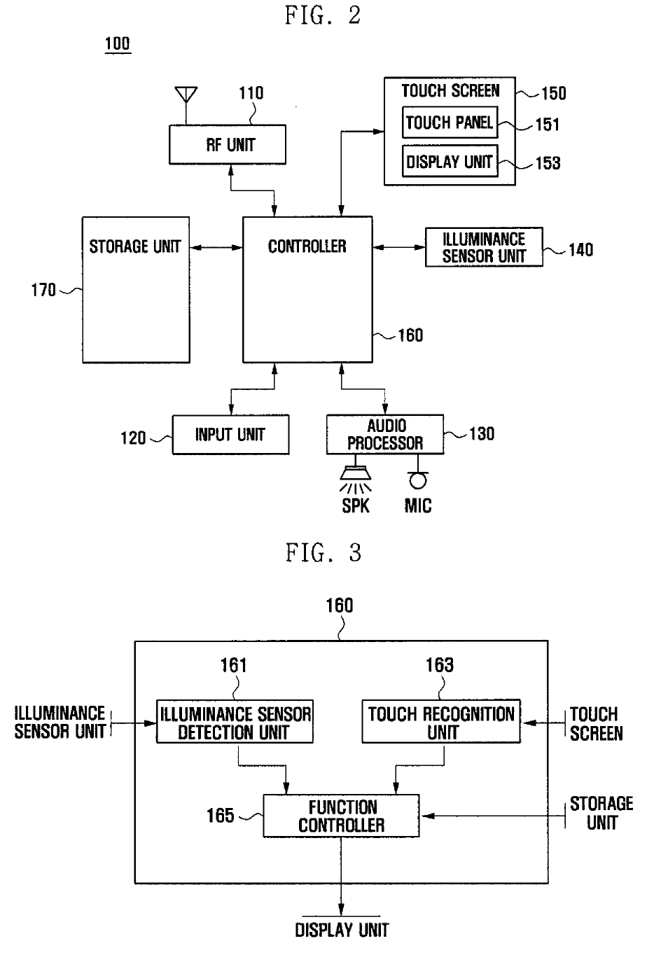

FIG. 2 is a block diagram illustrating a configuration of the mobile terminal of FIG. 1. The operation of each of the elements of the mobile terminal 100 for performing the above functions is described in detail with reference to FIG. 2.

Referring now to FIG. 2, the mobile terminal 100 preferably includes a radio frequency (RF) unit 110, an input unit 120, an audio processor 130, the illuminance sensor unit 140, the touch screen 150 including the touch panel 151 and the display unit 153, a controller 160, and a storage unit 170.

The mobile terminal 100 having the above-described exemplary configuration initializes each of the elements when power is supplied and in this case, the mobile terminal 100 controls activation of the illuminance sensor unit 140 and the touch screen 150. When a user touches the region of the illuminance sensor unit 140, the mobile terminal 100 detects a change in the intensity of illumination according to the touch, generates an illuminance event, and outputs the generated illuminance event to the controller 160. When the user touches a specific position of the touch screen 150, the touch screen 150 generates a touch event at the corresponding position and output the generated touch event to the controller 160. In this case, the illuminance sensor unit 140 detects how many changes in the intensity of illumination are generated by accurately recognizing a change in the intensity of illumination, which occurs when the user touches the illuminance sensor unit 140, and outputs corresponding results to the controller 160. Furthermore, the touch event output to the controller 160 includes position information about a region touched by the user and information about a touch down event or a touch up event. When the illuminance event and the touch event occur, the controller 160 controls activation of a configuration for switching a corresponding screen and performing of a corresponding function such that a specific user function of the mobile terminal 100 can be rapidly performed.

The RF unit 110 transmits and receives voice signals for a call function and data for data communication by the control of the controller 160. For transmission and reception of the signals, the RF unit 110 preferably includes an RF transmitter for up-converting a frequency of a signal to be transmitted and amplifying the signal, and an RF receiver for down-converting a frequency of a received signal and low-noise amplifying the signal. Particularly, when at least one of combinations of illuminance events and touch events generated by the illuminance sensor unit 140 and the touch screen 150, respectively occurs to fulfill preset conditions, the RF unit 110 controls to automatically attempt a call connection to a specific phone number. For example, when the illuminance sensor unit 140 senses touch of the region by a preset number of times (e.g. twice), the illuminance sensor unit 140 recognizes a change in the intensity of illumination according to the touch and outputs a corresponding result to the controller 160 in the form of an illuminance event. According to the illuminance event detected, the controller 160 activates the RF unit 110 and controls the RF unit 110 to output a call request message for a call connection to a specific phone number (e.g. the most recently called phone number or a phone number set by the user). Further, the user can generate a specific illuminance event using the illuminance sensor unit 140 and also generate a touch event by touching a specific region of the touch screen 150. The generated touch event is delivered to the controller 160. According to the illuminance event and the touch event received within a predetermined time period, the controller 160 activates the RF unit 110 to support an automatic call connection service. When a specific region of the touch screen 150 overlaps with the illuminance sensor unit 140, if the user touches the region of the illuminance sensor unit 140, the illuminance sensor unit 140 generates an illuminance event and simultaneously, the touch screen 150 can generate a touch event for the corresponding region. The controller 160 controls the RF unit 110 to perform the above operation according to the illuminance event and the touch event simultaneously generated.

The input unit 120 is equipped with a plurality of input keys and a plurality of function keys for receiving numeral or character information and setting various functions. The function keys preferably include direction keys, side keys, and hotkeys that are set to perform specific functions. Further, the input unit 120 generates key signals corresponding to user setting and to the control of the functions of the mobile terminal 100 and outputs the signals to the controller 160. The input unit 120 can be formed with a QWERTY keypad, a DVORAK keypad a 3×4 keypad, a 4×3 keypad, including a plurality of the keys. The input unit 120 outputs input signals, generated when the user presses a specific key of the keypad, to the controller 160. In this case, the input unit 120 generates various input signals according to application programs that are now being activated. When the touch screen 150 of the mobile terminal 100 is provided in the form of a full touch screen on the front side of an external casing, the input unit 120 may be omitted.

With continued reference to FIG. 2, the audio processor 130 includes a speaker (SPK) for reproducing audio data transmitted and received when a call is performed and a microphone (MIC) for collecting the user's voice when a call is connected or other audio signals. Further, when an illuminance event and a touch event simultaneously occur or consecutively occur within a predetermined time period, the audio processor 130 performs a corresponding application program operation (e.g. the execution of a menu screen or the execution of a message writing function) and outputs a corresponding guidance voice. In other words, the audio processor 130 outputs preset sound corresponding to the user function activated according to the generation of the illuminance event and the touch event, and when the user function is a call connection function, the audio processor 130 controls to automatically activate the microphone MIC.

The illuminance sensor unit 140 detects a change in the light, and when the corresponding change is converted to a preset value, the illuminance sensor unit 140 generates an illuminance event. Further, the illuminance sensor unit 140 outputs the generated illuminance event to the controller 160. A change in the intensity of illumination can occur according to the position of a shadow or the mobile terminal 100 and an angle at which light is radiated. Thus, when the illuminance sensor unit 140 is set to sensitively respond to such a change in the intensity of illumination, illuminance events can occur from moment to moment. Therefore, the sensitivity of the illuminance sensor unit 140 appropriately controls generating the illuminance event only when a change in the intensity of illumination occurs to have a preset value or more.

The touch screen 150 sets an image and coordinate values corresponding to a plurality of the input keys and function keys for receiving number information or character information from the user and for setting various functions, and when a touch event occurs, the touch screen 150 outputs the corresponding touch event to the controller 160. The function keys include direction keys, side keys, and hot keys which are set to perform specific functions. Further, the touch screen 150 generates key signals corresponding to user setting and control of the functions of the mobile terminal 100 and outputs the generated key signals to the controller 160. The touch screen 150 includes the touch panel 151 and the display unit 153.

The touch panel 151 generates touch events, including position information about a region touched by the user (or stylus) and information about touch down, touch up, or touch drag and outputs the touch events to the controller 160. The touch panel 151 is disposed at the front side of the external casing of the mobile terminal 100. In this case, at the front side of the external casing at which the display unit 153 (“display”) is disposed, the touch panel 151 is preferably disposed to cover fully cover the display 153. Accordingly, the size of the touch panel 151 is greater than that of the display unit 153. Further, the touch panel 151 is formed to cover the illuminance sensor unit 140 located at one side of the external casing of the mobile terminal 100 or is disposed to enclose a region at which the illuminance sensor unit 140 is located. Thus, while the user of the mobile terminal 100 covers the illuminance sensor unit 140 with his finger, the touch panel 151 generates a touch event resulting from the finger contacting with a corresponding region or a region adjacent to the illuminance sensor unit 140 and outputs the generated touch event to the controller 160.

The display unit 153 outputs a screen activated according to a selected or pre-programmed function of the mobile terminal 100. For example, the display unit 153 can output a boot screen, standby screen, menu screen, and call screen. A Liquid Crystal Display (LCD) can be used as the display unit 153. In this case, the display unit 153 includes an LCD controller, memory for storing data, and LCD display element. In the present exemplary embodiment, the LCD can be implemented using a touch screen method, and the screens of the display unit 153 can be operated as input units together with the touch panel 151. Particularly, when at least one of an illuminance event and a touch event occurs, when a specific user function is activated according to the occurrence of the corresponding event, the display unit 153 outputs a screen corresponding to the user function.

The storage unit 170 comprises a machine readable medium for storing machine readable executable code, and stores, inter alia, application programs for operating the functions according to the present exemplary embodiment, such as a touch user interface (UI) operating program for operating the touch screen, an illuminance sensor operating program for operating the illuminance sensor unit 140, and user data. The storage unit 170 performs a function of temporarily storing illuminance events and touch events. The storage unit 170 includes a program region and a data region.

The program region also preferably stores an operating system (OS) for booting the mobile terminal 100, a complex function operating program according to illuminance events and touch events, application programs for other option functions (e.g. a sound reproduction function and an image or moving picture reproduction function) of the mobile terminal 100. The complex function operating program controls to activate a specific user function of the mobile terminal 100 according to an illuminance event received from the illuminance sensor unit 140. For example, when a user function of the mobile terminal 100 is set to directly activate when a specific illuminance event occurs and the generated illuminance event is received from the illuminance sensor unit 140, the complex function operating program controls to immediately execute a preset user function. That is, when a function of changing the brightness of the display unit 153 according to an illuminance event is included in the mobile terminal 100, when a specific illuminance event is generated by the illuminance sensor unit 140, the complex function operating program can control to display the brightness of the display unit 153 differently from a previous brightness. Further, when a specific illuminance event occurs, the complex function operating program can control performance of the output of a screen for writing a message, a call connection based on a specific phone number, and an automatic switch to a sound mode and an etiquette vibration mode. After the mobile terminal 100 is booted and the illuminance sensor unit 140 is activated, the complex function operating program can be loaded onto the controller 160 and used to control functions corresponding to illuminance events generated by the illuminance sensor unit 140.

When the touch screen 150 is activated, the complex function operating program is loaded onto the controller 160 and controls a user function according to a touch event generated by the touch screen 150. That is, when the touch screen 150 is activated, the complex function operating program can output a specific menu screen or a specific screen to the display unit 153 and also reset the touch panel 151. Further, the complex function operating program can control a specific function based on position information about a touch event generated by the touch panel 151 and position information about each of the elements of a screen that is output by the display unit 153.

Further, the complex function operating program receives an illuminance event and a touch event and determines whether or not the corresponding events correspond to preset conditions, and when the corresponding events, having transferred to fulfill the preset conditions occur, the complex function operating program controls to activate a preset user function. That is, the complex function operating program controls the execution of a function corresponding to the illuminance event and the touch event and also controls activation of a specific user function when the illuminance event and the touch event fulfill a preset conditions (e.g. when a specific touch event occurs within the preset time period after a specific illuminance event occurs or when a specific illuminance event and a specific touch event simultaneously occur).

The data region is a region in which data generated according to use of the mobile terminal 100 are stored. User data (e.g. phonebook information, photographs, picture images, and contents) of the mobile terminal 100 or pieces of information corresponding to the user data can be stored in the data region. The data region can store a preset value of the illuminance sensor unit 140 and a preset value of the touch screen 150 and provide a preset value by the control of the controller 160 when each of the elements is reset. Further, the data region may perform a function of a buffer for temporarily storing illuminance events and touch events. The buffer may be included in the controller 160.

The controller 160 preferably controls the supply of power to the mobile terminal 100, the activation of the elements, and the flow of signals between the elements. Particularly, in the present exemplary embodiment, the controller 160 controls the activation of a user function of the mobile terminal 100 according to an illuminance event generated by the illuminance sensor unit 140 and also controls a proper user function to execute with the generated illuminance event associated with a touch event generated by the touch screen 150. The controller 160 includes an illuminance sensor detection unit 161, touch recognition unit 163, and function controller 165, as shown in FIG. 3.

The illuminance sensor detection unit 161 receives an illuminance event generated by the illuminance sensor unit 140 while monitoring and outputs the received illuminance event to the function controller 165. The touch recognition unit 163 receives a touch event generated by the touch screen 150 while monitoring and outputs the received touch event to the function controller 165.

The function controller 165 preferably receives an illuminance event and a touch event from the illuminance sensor detection unit 161 and the touch recognition unit 163, respectively, and performs a corresponding function. When an illuminance event occurs, the function controller 165 controls to activate various user functions (e.g. a function of automatically controlling a change in the brightness of the display unit 153, a function of automatically connecting a call to a specific phone number, a function of automatically activating the message writing window, and a function of automatically switching the sound mode and the etiquette mode) that are set to the illuminance event. When a touch event occurs, the function controller 165 controls the activation of a specific function (e.g. when a touch event occurs in a specific menu item, the activation of the corresponding menu item) connected to position information about the generated touch event. Furthermore, when a specific illuminance event and a specific touch event simultaneously occur or sequentially occur at specific time intervals, the function controller 165 controls to activate various user functions of the mobile terminal 100 (e.g. a function of automatically controlling a change in the brightness of the display unit 153, function of automatically connecting a call to a specific phone number, function of automatically activating the message writing window, and function of automatically switching the sound mode and the etiquette mode).

Each of the illuminance sensor detection unit 161, the touch recognition unit 163, and the function controller 165 all can control the user functions of the present invention according to the complex function operating program loaded onto the program region of the storage unit 170.

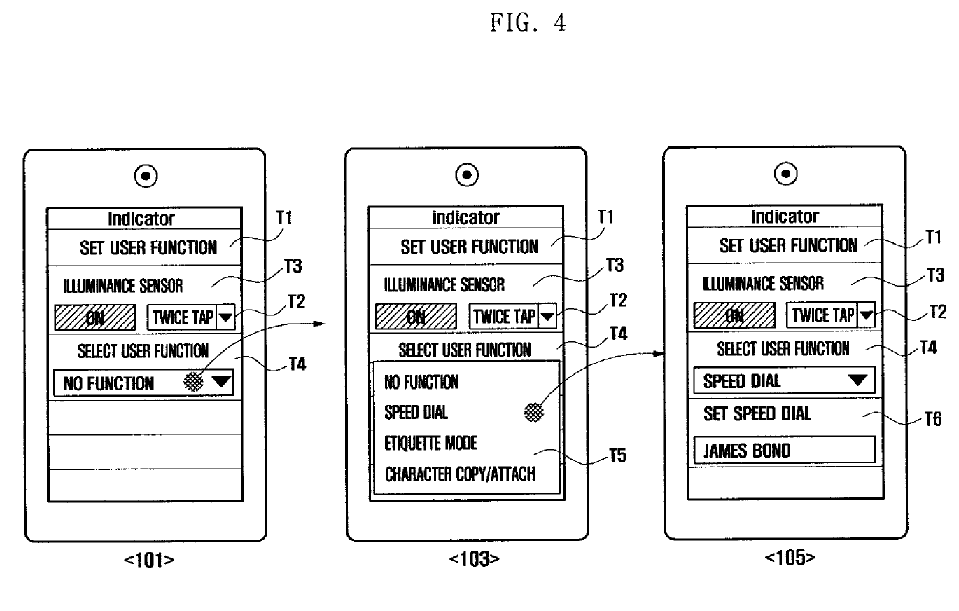

FIG. 4 illustrates examples of screens for setting user functions that can be performed according to at least one of combinations of illuminance events and touch events in the mobile terminal of FIG. 1.

Referring now to FIG. 4, on a screen 101, the display unit 153 of the mobile terminal 100 outputs an information indication region T1 for displaying text information for indicating a user function setting screen, a sensor setting region T3 for determining whether to activate an illuminance sensor included in the illuminance sensor unit 140 and for setting a pattern of an illuminance event generated by the illuminance sensor unit 140, and a function selection region T4 for selecting an illuminance sensor function. The sensor setting region T3 can include a check region (e.g. a region in which “on” or “off” can be selected) for activating or inactivating the illuminance sensor. When “on” is selected, the sensor setting region T3 can further output a pattern setting region T2 for setting a pattern of a generated illuminance event. Accordingly, the user of the mobile terminal 100 can set a pattern (e.g. “twice tap”) of the illuminance event using the pattern setting region T2. Only the setting of the illuminance sensor unit 140 is described, however the mobile terminal 100 of the present invention can support both an illuminance event and a touch event so that they are set together in conjunction with each other. For example, when the user selects the pattern setting region T2, the mobile terminal 100 can output a list of menu items, such as “twice tap illuminance sensor unit”, “touch event within a preset time period after twice tapping illuminance sensor unit”, and “twice tap illuminance sensor unit and touch screen”, in a drop-down manner. A person of ordinary skill in the art understands and appreciates that the claimed invention is not limited to the arrangements shown and described, and the areas may be arranged differently, relatively larger or small sizes, or even some not included at all.

When the user of the mobile terminal 100 selects “on” in order to set the activation of the illuminance sensor, the display unit 153 can output the function selection region T4. When the user of the mobile terminal 100 clicks on the function selection region T4, the mobile terminal 100 can output the activation of a window for selecting various functions in a drop-down manner shown on a screen 103 from a state “no function” shown on the screen 101. Accordingly, the function selection region T4 can output menu items, such as “no function,” “speed dial”, “etiquette mode”, and “character copy/attach”.

On the screen 103, when the user of the mobile terminal 100 selects the menu item “speed dial” displayed in the function selection region T4, the mobile terminal 100 can reduce the drop-down window activated in the function selection region T4 and output only the selected menu item “speed dial”, as shown on a screen 105. Further, the display unit 153 can, for example, automatically output an additional information region T6 in which the user can select another party for a call according to the activation of the illuminance sensor according to the function “speed dial.” In an additional information region T6, the user can directly input numbers corresponding to another party's phone number using the input unit 120 or the touch screen 150, or can select specific information stored in a phonebook. If the user of the mobile terminal 100 selects “James bond” from the phonebook, the additional information region T6 can output “James bond” selected by the user or a phone number corresponding to “James bond.”

The additional information region T6 according to some exemplary embodiments of the present invention can be changed according to the function selection region T4. For example, when a user function is selected as a broadcasting viewing-related function in the function selection region T4, the additional information region T6 can be operated as a channel setting region for viewing broadcasting. For example, when a web function is selected as a user function in the function selection region T4, the additional information region T6 can be operated as a region for inputting the address of a web page to be accessed based on a web browser. For example, when a user function is selected as a schedule check function in the function selection region T4, the additional information region T6 can support a function of selecting a date or the range of a date to be checked. That is, the user can select the range of a schedule to be checked, such as “today,” “yesterday and today based on today,” and “week,” through the additional information region T6.

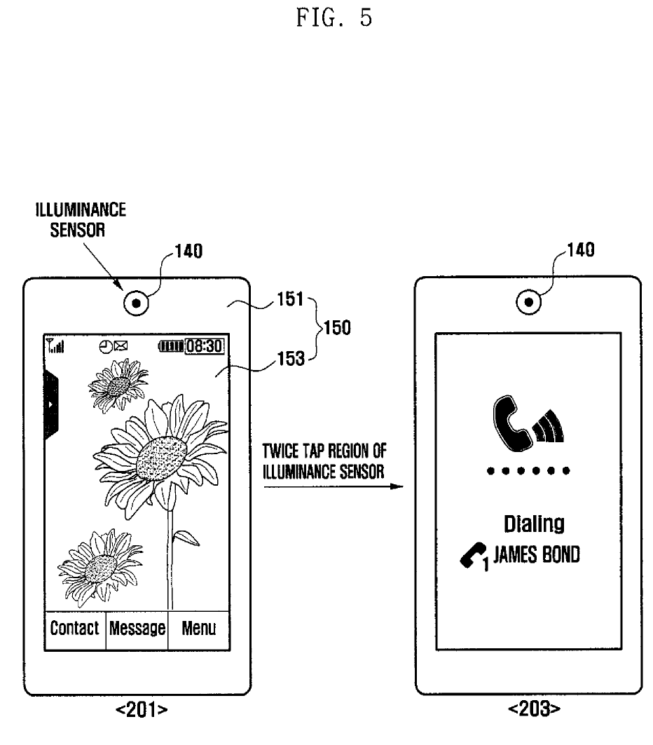

FIG. 5 illustrates examples of screens for operating a speed dial function may appear when in the device in FIG. 4, the user of the mobile terminal 100 sets the illuminance sensor function and then activates the illuminance sensor.

Referring now to FIG. 5, the display unit 153 of the mobile terminal 100 outputs a specific standby screen shown on a screen 201. In this case, the standby screen is displayed in a region of the display unit 153, and the touch panel 151 is disposed at an entire region of the display unit 153 and at the front side of the external casing other than a region of the display unit 153. Thus, the touch panel 151 is disposed to cover a region at which the illuminance sensor unit 140 is located or, as shown in FIG. 1, is disposed to cover regions adjacent to the region at which the illuminance sensor unit 140 is located. Further, the touch panel 151, as described above, may be disposed to cover only the region of the display unit 153. In such a configuration, the user of the mobile terminal 100 can perform an operation (e.g. an operation of twice tapping the illuminance sensor unit 140) that fulfills preset conditions. Accordingly, the illuminance sensor unit 140 can detect a change in the intensity of illumination resulting from, for example such two taps, to generate an illuminance event corresponding to the change in the intensity of illumination, and output the generated illuminance event to the controller 160. Next, the user of the mobile terminal 100 can perform a specific operation on the touch screen 150 (e.g. an operation of twice tapping the touch panel 151). Therefore, the touch panel 151 can generate a touch event according to the two taps and output the generated touch event to the controller 160.

When the touch panel 151 is disposed to cover the illuminance sensor unit 140 of the mobile terminal 100 or to enclose regions adjacent to the region of the illuminance sensor unit 140, if the user of the mobile terminal 100 twice taps the illuminance sensor unit 140, the illuminance sensor unit 140 can output an illuminance event generated according to the two taps to the controller 160, and the touch panel 151 can generate a touch event generated according to the two taps and output the generated touch event to the controller 160. Again, the person of ordinary skill in the art understand there could be three taps to generate a function, etc.

When an illuminance event generated according to two taps is received from the illuminance sensor unit 140, a specific touch event is received within a predetermined time period after an illuminance event is received, or an illuminance event and a touch event are simultaneously received, the controller 160 of the mobile terminal 100 recognizes the corresponding events as events for activating the speed dial function. Thus, the controller 160 controls to perform a function of automatically connecting a call to a phone number set to the speed dial function, as shown on a screen 203. Here, the mobile terminal 100 preferably includes a table for activating a speed dial function when an illuminance event occurs according to two taps, a specific touch event occurs within a predetermined time period after the reception of an illuminance event, or an illuminance event and a touch event simultaneously occur. The table can be edited by the user of the mobile terminal 100.

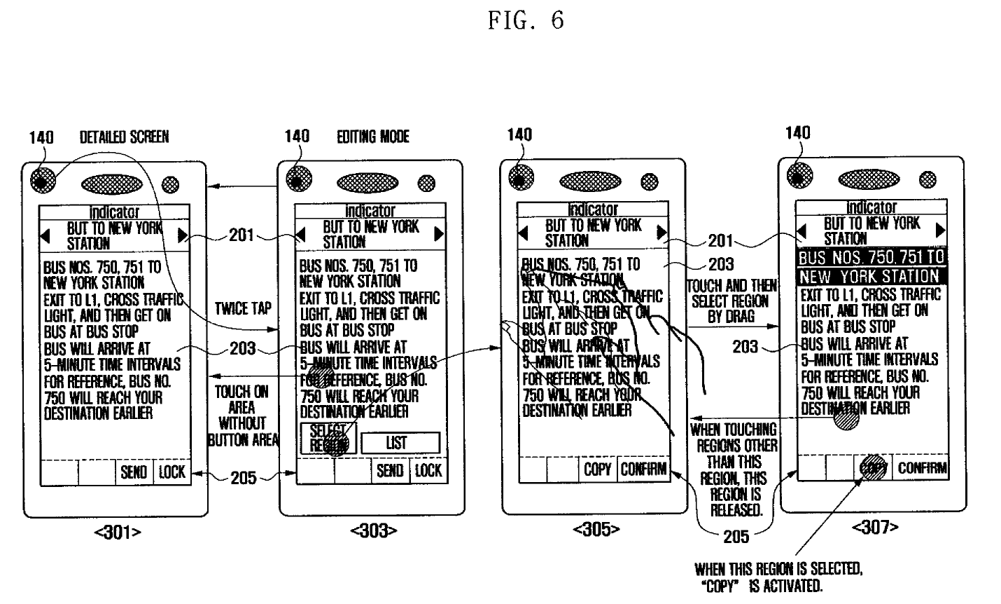

FIG. 6 illustrates some examples of screens for operating a message writing function of the mobile terminal when the illuminance sensor is activated. A person of ordinary skill in the art should assume that the user of the mobile terminal 100 performs a specific operation on the illuminance sensor unit 140 of the mobile terminal 100 in order to use the message writing function and the mobile terminal 100 activates the message writing function according to the specific operation. For example, when the user of the mobile terminal 100 twice taps the illuminance sensor unit 140, the mobile terminal 100 can output a message view screen. In this state, when the user of the mobile terminal 100 selects a specific message and checks the selected message, the mobile terminal 100 can output a screen for checking the message, as shown on a screen 301.

Referring now to FIG. 6, when the user of the mobile terminal 100 selects a specific message and checks the specific message, the mobile terminal 100 can output contents of the specific message to the display unit 153, as shown on the screen 301. That is, the mobile terminal 100 can include a title region 201 for displaying a part of the contents of the specific message as a title, a content region 203 for displaying the entire contents of the message, and a button region 205 for sending a displayed message to other mobile terminal 100 or outputting a menu button for locking the specific message so that the message is not deleted. The illuminance sensor unit 140 can be disposed at one side (e.g. at an upper left portion) of the mobile terminal 100. When the user of the mobile terminal 100 wants to edit the contents of the specific message while checking the contents of the specific message, the user can perform a specific operation in the region of the illuminance sensor unit 140 (e.g. an operation of twice touching the region of the illuminance sensor unit 140). Here, the mobile terminal 100 can use not only the illuminance event generated by the illuminance sensor unit 140, but a touch event generated by the touch screen in order to provide a message screen switch function for editing the specific message. For example, the mobile terminal 100 can use an illuminance event, a touch event generated within a predetermined time period after an illuminance event, or both an illuminance event and a touch event simultaneously occurring as an input signal for the message screen switch function according to the user' or a designer's setting. In order for the user to easily generate the input signal, the mobile terminal 100 controls to display a method of generating the input signal at one side of the screen. In other words, the mobile terminal 100 can display a method of generating the input signal for the message screen switch function in at least one of the contents region 203 and the button region 205 as a combination of a text and an image. For example, the mobile terminal 100 controls display of text information related to “edit: twice tap illuminance sensor unit”, “edit: touch screen after tapping illuminance sensor unit”, or “edit: simultaneously touch illuminance sensor unit and touch screen”, and image information corresponding to the text information at one side of the screen.

Next, the mobile terminal 100 can display the button region 205 for editing contents of the specific message in a specific region of the display unit 153, as shown on a screen 303. That is, the mobile terminal 100 can display a region selection button for editing a message and a list button for searching for other message list. When, on the screen 303, the user of the mobile terminal 100 typically does not click on the region selection button and the list button, but rather touches another region (e.g. a region in which the contents of a message are displayed), the mobile terminal 100 can return to the screen 301. When, on the screen 303, the user of the mobile terminal 100 clicks on the region selection button, the mobile terminal 100 switches to a screen for supporting the message editing function, such as that shown in a screen 305. Here, the mobile terminal 100 can modify the button region 205 shown in the screen 303 so that the button region 205 includes buttons for editing a message. In other words, the mobile terminal 100 can change the button region 205, including the buttons ‘send’ and ‘lock’ on the screen 303, into the button region 205 including buttons ‘copy’ and ‘confirm’.

With continued reference to FIG. 6, on the screen 305, the user of the mobile terminal 100 can perform a touch & drag operation for selecting a part of the contents region 203 in which the contents of the message are displayed. In other words, the user of the mobile terminal 100 can touch an edge region of the upper left side of the contents region 203 using his finger (or stylus) and then drag the touched edge region to a lower right side of the contents region 203 to include a region to be selected. According to the touch & drag operation, the mobile terminal 100 can reverse a shadow so that the selected region is distinguish from other regions as shown on a screen 307 and output a reversed region. Here, when the touch & drag action is diagonally performed, the mobile terminal 100 can support a function of selecting the contents of a message, included in a square region including a start point and an end point of the diagonal line.

On the screen 307, the user of the mobile terminal 100 can copy the selected region using a copy button provided in the button region 205. In this case, when the copy button provided in the button region 205 of the screen 305 remains inactive and a part of the contents region 203 is then selected, the mobile terminal 100 can control activation of the copy button. When the user of the mobile terminal 100 does not touch the button region 205, but touches a specific region of the contents region 203, the mobile terminal 100 controls to return a corresponding screen to the screen 305.

When a message is edited, when a change in the intensity of illumination corresponding to an operation (e.g. two taps) fulfilling preset conditions occurs in the illuminance sensor unit 140, the mobile terminal 100 controls performing a function of automatically sending the edited message to other mobile terminal 100. When a phone number of the corresponding mobile terminal 100 to which the edited message is to be sent is not set, the mobile terminal 100 controls output of a screen for inputting the phone number.

As described herein above, the mobile terminal 100 of the present invention can rapidly and conveniently activate various user functions using the illuminance sensor unit 140 and can perform a fast screen switch operation using the illuminance sensor unit 140 even in an activated user function.

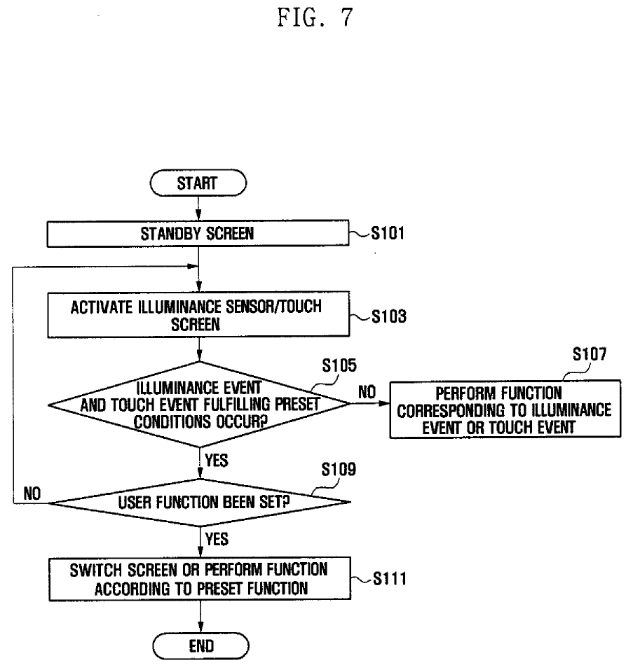

FIG. 7 is a flowchart illustrating an operational example of inputting method of a mobile terminal according to another exemplary embodiment of the present invention.

Referring now to FIG. 7, in the input method of the present exemplary embodiment, when power is supplied to the mobile terminal 100, the controller 160 distributes the power into the elements of the mobile terminal 100, thereby resetting the elements. At step (S101), the controller 160 controls to output a specific standby screen to the display unit 153. The standby screen can be outputted even when the mobile terminal 100 is awaken from a sleep state.

In order to receive an input signal from the user, at step (S103) the controller 160 controls to activate the illuminance sensor unit 140 and the touch screen 150. The illuminance sensor unit and the touch screen may be activated during resetting the elements of the mobile terminal 100.

At step (S105), the controller 160 determines whether an illuminance event and a touch event occur to fulfill preset conditions by the illuminance sensor unit 140 and the touch screen 150. The preset conditions comprise input conditions for supporting a specific function of the mobile terminal 100 (e.g. a user function of the mobile terminal 100) to immediately execute the specific function without selecting corresponding menu items. If an illuminance event and a touch event do not occur, at step (S107) the mobile terminal 100 controls to perform a function according to a generated event (i.e. the illuminance event or the touch event).

At step (S109), if an illuminance event and a touch event occur, the controller 160 determines whether a user function corresponding to the illuminance event and the touch event is set. If the illuminance event and the touch event are not set, the process returns to step S103. Here, the mobile terminal 100 can output a pop-up window, representing that a function corresponding to the illuminance event and the touch event fulfilling the preset conditions is not set, or a pop-up window for inquiring the user to switch to a setting screen for setting a specific function according to the input signal of corresponding conditions. When the user selects the switch to the setting screen in the pop-up window, the mobile terminal 100 can output the setting screen, as shown in FIG. 4.

Still referring to FIG. 7, at step (S111) if a user function corresponding to the illuminance event and the touch event are set, the controller 160 controls the switch of a screen or the execution of the user function according to the preset function. Here, the user function can include functions, such as a speed dial function of immediately connecting a call to a specific phone number, a function of switching to the sound mode or the etiquette mode, and the message writing or editing function, which are set to be performed when an illuminance event and a touch event fulfilling the preset conditions occur.

Here, the user functions are not limited to the speed dial function, the sound or etiquette mode switch function, and the message writing or editing function. The user functions relate to the user functions of the mobile terminal 100 and include various functions that can be set by the user, such as a broadcasting viewing-related function of receiving broadcasting data based on a preset channel and immediately outputting the received broadcasting data, a schedule check function of immediately checking today's schedule, and a web function of activating a web browser and accessing a corresponding web page based on a preset address.

As described above, in the input device and method for the mobile terminal according to exemplary embodiments of the present invention, complex input signals can be generated, and various user functions of the mobile terminal can be easily accessed and operated based on the generated complex input signals.

Although exemplary embodiments of the present invention have been described in detail hereinabove, a person of ordinary skill in the art should understand and appreciate that many variations and modifications of the basic inventive concepts herein described, will still fall within the spirit and scope of the exemplary embodiments of the present invention as defined in the appended claims.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method of processing input by a mobile terminal, comprising:
(a) generating a specific illuminance event and a specific touch event;
(b) determining by a controller whether a specific user function of the mobile terminal associated with the generating of the specific illuminance event and the specific touch event is set; and
(c) activating the user function by the controller if the specific user function in (b) is set.

2. The method of claim 1, wherein the generating in step (a) comprises detecting a change in an intensity of illumination occurring in response to an illuminance sensor unit being tapped for a predetermined number of times.

3. The method of claim 1, wherein the generating in step (a) comprises generating the specific touch event within a predetermined time period after detection of the specific illuminance event occurs.

4. The method of claim 1, wherein the generating in step (a) comprises one of: simultaneously generating the specific illuminance event and the specific touch event; or
generating the specific illuminance event during detection of the specific touch event.

5. The method of claim 1, further comprising:
pattern setting a region of a generated illuminance event to set conditions for generating the specific illuminance event and the specific touch event; and
setting a user function to execute when an event corresponding to the pattern setting occurs.

6. The method of claim 5, further comprising setting a phone number or an index corresponding to the phone number, if the user function comprises a speed dial function of automatically connecting a call to a specific phone number.

7. The method of claim 5, further comprising setting a channel if the user function comprises a broadcasting viewing-related function.

8. The method of claim 5, further comprising setting an address of a web page if the user function comprises a web function.

9. The method of claim 1, wherein activating the user function comprises at least one of:
activating a message writing function of the mobile terminal;
activating a message editing function of the mobile terminal;
activating an automatic message transmission function of the mobile terminal; and
outputting a phone number input screen for automatically transmitting messages of the mobile terminal.

10. An input device of a mobile terminal, comprising:
an illuminance sensor for detecting a change in an intensity of illumination and for generating an illuminance event according to the detected change;
a touch screen comprising a display unit and a touch panel for generating a touch event in response to sensing a touch;
a storage unit comprising a machine readable medium for storing an application program comprising machine executable code corresponding to a user function automatically performed when a specific illuminance event and a specific touch event occur; and
a controller for determining whether generating of the specific illuminance event and the specific touch event has occurred and controlling activation of a preset user function associated with generating of the specific illuminance event and the specific touch event.

11. The input device of claim 10, wherein the illuminance sensor detects a change in the intensity of illumination generated in response to a region of the illuminance sensor being tapped for a predetermined number of times and generates an illuminance event according to the change in the intensity of illumination generated.

12. The input device of claim 10, wherein the controller controls activation of the user function when the specific illuminance event occurs within a predetermined time period after the specific illuminance event occurs.

13. The input device of claim 10, wherein the controller controls one of activation of the user function when the specific illuminance event and the specific touch event simultaneously occur or activation of the user function when the specific illuminance event occurs during the specific touch event.

14. The input device of claim 13, wherein the touch panel is disposed to cover the illuminance sensor.

15. The input device of claim 13, wherein the touch panel is disposed to enclose a region of the illuminance sensor.

16. The input device of claim 10, wherein the display unit outputs:
a pattern setting region for setting conditions to generate the specific illuminance event and the specific touch event based upon a predetermined pattern; and
a region for setting a user function to execute when an event corresponding to the pattern occurs.

17. The input device of claim 16, wherein the display unit outputs a region for setting a phone number or an index corresponding to the specific phone number if the user function is a speed dial function of automatically connecting a call to a specific phone number,.

18. The input device of claim 16, wherein the display unit outputs a region for setting a channel if the user function is a broadcasting viewing-related function.

19. The input device of claim 16, wherein the display unit outputs a region for setting an address of a web page if the user function is a web function.

20. The input device of claim 10, wherein the controller controls, when the specific illuminance event and the specific touch event occur, performance one of: an output of a message writing screen of the mobile terminal, an output of a message editing screen of the mobile terminal, an automatic transmission of a message of the mobile terminal, and an output of a phone number input screen for automatically transmitting a message of the mobile terminal.
